(19) United States
(12) Patent Application Publication
(10) Pub. No.: US 2017/0186066 A1
(43) Pub. Date: Jun. 29, 2017

(54) System and Method of Searching Style and Fashion

(71) Applicant: Susan Kaplan BRUCH, Houston, TX (US)

(72) Inventor: Susan Kaplan BRUCH, Houston, TX (US)

(21) Appl. No.: 15/389,891

(22) Filed: Dec. 23, 2016

Related U.S. Application Data
(60) Provisional application No. 62/272,309, filed on Dec. 29, 2015.

(51) Int. Cl. G06Q 30/06

(52) U.S. Cl. CPC G06Q 30/0623

(57) ABSTRACT

A method and system for searching databases of fashion and style using query catching metadata, API's, SKU numbers, GPS tracking and data feeds to filter by search terms, text keywords, numeric values, visual recognition, and geographic location filtered by the user. The method and system simplifies and improves the user experience by allowing full customization of the above queries to return results based upon term relationships, editorial assertions, visual recognition, SKU matching and barcoding. The method and system uses an underlying search engine that enhances search results by populating inventory through SKU numbers, numeric values as well as aggregates relative style content and displays links on the results page of retailers, designer brands, style content providers, geographic locations to enhance automatic indexing.

### RELATED APPLICATIONS

The present application is a non-provisional application of Provisional Application No. 62/272,309 filed on Dec. 29, 2015 and hereby claims priority benefit thereto, the contents of which is hereby incorporated by reference in its entirety.

### FIELD OF THE INVENTION

The present invention relates generally to the field of clothing fashion and style including such fashion and styles found in retail facilities (both on-line and street side or in-store), designer brands and style content. More particularly, it relates to the processes and systems used to effect search, browse, and buy functions of a clothing fashion-only search engine, while solving many front end and back end problems for both users and stakeholders within an omni-channel process, by combining a number of different software platforms, for a multifunctional system and method.

Accordingly, the invention employs combined software that works together to effect search, browse, and buy functions to a user, while also enabling both customized meta-data and specific algorithms to be collected by industry partners, that include where sales originate, and follows through to point of sale.

### BACKGROUND OF THE INVENTION

An objective of the present invention is to solve the clothing fashion industry's problems by rethinking the entire big-picture shopping infrastructure, and then restructuring the search process by using a “see it—buy it” mentality on the front end, and a SKU based (product ID) number search crawl on the backend. The front end links a consumer through one of at least seven different possible shopping channels. These channels include, for example, buying through on-line, in-store, digital, mobile, social, visual and editorial content using forms of artificial intelligence such as visual, text and numeric recognition and other software platforms.

By creating a back-end based upon a service identification code for a product, known as a stock keeping unit (“SKU”) numbers rather than existing application programming interfaces (“APIs”) based system, search processes will be initiated and enabled through singular product identification numbers rather than the retailers that carry them. This allows for a more reliable search on the consumer shopping or front-end, and a more substantial back-end data collection for industry stakeholders. By integrating both front and back end processes, the invention embodied in, and therefore sometimes referred to herein by, its commercial website hosting name of “Your Style Unzipped”, eliminates the existing problems of current search engine models through customization, sourcing, directory, search terms, and the integration of style content, and provides a standardized, unbiased platform for stakeholders regardless of size, experience, or paid search.

Unlike prior art systems and methods, the present invention is a customized search engine dedicated to both the customer experience and stakeholder process. The invention is intended to merge global retailers (both on-line and in-store or street-side), designer brands and all fashion content into one destination website serving women's, men's, children's, bridal, and maternity categories. An integrated mobile application brings additional shopping/retail enhancements to mobile and smart devices using both existing and developing technologies.

The fully customizable search system allows users to search, browse, buy and save their favorite retailers, brands, style voices, and locations into their virtual “closet” using a Universal Closet concept from one destination website, and becomes a uniquely personal “smart” shopping tool that remembers everything from clothing preferences, prices, and colors to historical purchases, and designer & retail preferences.

The present invention is configured to allow users to access a “See it—Buy it” shoppable search engine on any device and through at least seven different channels including on-line, in-store, digital, mobile, social, visual and editorial. These options extend far beyond prior art methods of search, which are relegated to aggregating merely on-line content and are based on a “paid for placement” of keywords and bidding process of terms and phrases. By contrast, the system of the present invention is directory based, alphabetical for retailers, brands, and style content, and geographic for in-store retailers. Thus, there will be no need for industry stakeholders to pay for the use of terms or keywords on retailer or designer websites.

The innovations of the present invention include combining technologies that offer consumers the ability to shop from content on all channels: on-line, in-store, mobile, digital, social, visual, editorial, on the front end, while collecting data on the back end regarding consumer buying trends, fashion style, retail and designer content, supply chain, geographic retail directories, data analytics/collection/algorithms, search engine marketing (“SEM”) and search engine optimization (“SEO”). Further, users are enabled to filter, save, and collect information on inventory, pricing, availability, etc., while stakeholders can collect and analyze data. Directories include GPS/Mapping capabilities. The back end is built on known software platforms including WordPress CMS (PHP/MySQL on Linux AWS virtual server), SKUIQ and SalesForce, with a custom theme and proprietary plug-ins. Intelligent image-based analytics are implemented to understand user generated content from social media.

The front end (sometime referred to herein as the “shopping process”) is also based on well-known commercially available platforms, including HTML5/CSS3 and mobile responsive (Bootstrap) with custom JavaScript/jQuery, including Ajax and various jQuery plugins (jScroll). Google Analytics and SalesForce is used to provide web analytics to track and report on website traffic.

Mobile applications incorporate body scanning and barcoding technologies, in addition to incorporating the above described front-end and back-end processes.

### SUMMARY OF THE INVENTION

The present invention is directed to a system and method for searching databases related to style and fashion. The method and system may be used, for example, by shoppers for searching databases of retail facilities, on-line shopping services, editorial material, publications, and industry newsletters, etc., all related to fashion and style.

The invention, more specifically, is related to a method and system for searching databases of fashion and style using query catching metadata, API's, SKU numbers, GPS tracking and data feeds to filter by search terms, text keywords, numeric values, visual recognition, and geographic location filtered by the user. The method and system of the invention simplifies and improves the user experience by allowing full customization of the above queries to return results based upon term relationships, editorial assertions, visual recognition, SKU matching and barcoding. The method and system uses an underlying search engine that enhances search results by populating inventory through SKU numbers, numeric values as well as aggregates relative style content and displays links on the results page of retailers, designer brands, style content providers, geographic locations to enhance automatic indexing.

By way of example, the on-line search channel begins by a user logging onto the website hosting the present invention (www.yourstyleunzipped.com) (the “hosting website”) from either a desktop or a mobile application. From there users have several choices depending upon what they are searching.

First, they can read “featured links” on the Home Page of the hosting website and click through to any content provided using external links that offer a direct point-of-sale for that/those items. Featured links can include any of the following: Pop-up stores, Catalog, Shop The Runway, Video Shopping, and more innovative technologies as they become available.

Second, they can search by a “clothing” category or specific clothing item using keywords. The SKU based system will associate the keyword with options already loaded on the back-end of the site through direct data feeds from designer brands and retailers as well. Once options pop up from the SKU's, a list of retail options who stock that number will also appear, whether they are street side boutiques, stores or on-line dot coms. Users can click on one, or all of the options to compare sizes, pricing and availability and then click to purchase, save to their universal closet, save for sale pricing, restocking or save to style “likes”. Users can also move directly to an external link of the chosen retailer and follow their site through to the point of sale.

Third, they can search by “retailer” in the featured or alphabetical listing section. Featured retailers have a more prominent positioning on the site and can include many point of sale options like designer collaborations, special sales, seasonal events, or promotions for the user to access. The retail section is divided into two areas, on-line and street-side. On-line works by routing users who click on the feature to the direct dot com of the retailer. The street-side section however, links through the back-end directly to the “locations” option which is connected with GPS Location and Mapping Technology. This enables users to search by country, state, city, or zip code and then filter what they're searching for. For example: Search: #77056; Clothing Filter: skirt; Color: black; and Size: 4.

Once the options in that zip code come up, users can click directly to that retailer's website (sometime herein referred to as a “dot com”), get a better text and visual description of the item, make arrangements to hold the item to buy in-store using communication technology with the store, or purchase for direct delivery through various services, such as Deliv, Localz or other similar services. Users will follow the retailer's specific guidelines and services available through that particular retailer.

Fourth, users can search by “designer” and see featured brands as well as scroll down an alphabetical listing of all designers included on the site. Featured retailers have a more prominent positioning on the site and can include their entire collections with attached points of sale, or retail links where sales can be made. Collections can be in the form of catalogs, Shop The Runway, video or photo presentations, and Pop-Up stores. They may include retail collaborations, special sales, events, or promotions for the user to access. The alphabetical listing will have a link to the brands preferred dot com.

Fifth, users can search by “location” as mentioned above which is connected with GPS Location and Mapping Technology. This enables users to search by country, state, city, or zip code and then filter what they're searching for. For example: Search: #77056; Clothing Filter: skirt; Color: black; and Size: 4.

As above, once the options in that zip code come up, users can click directly to that retailer's dot com, make arrangements to hold the item to buy in-store using communication technology with the store, or purchase for direct delivery through various services, such as Deliv, Localz or other similar services. Users will follow the retailers specific guidelines for purchase and services available through that particular retailer.

If a user wants to search by “country, city or state”, retailers in those areas will come up alphabetically with links to their specific dot com (web site) or featured link. For example: Search: Paris, France; Filter: Couture (it can be a grouping of clothes like denim, lingerie), or specific item by keywords, Street Name: Champs Elysees or postal code. Size, and Color preferences. Example: Search Paris, France, Champs Elysees for a “Short Black Dress, Size 4.

Again, once those options come up, featured partners will include hours of operations, brands carried, and other store information. Users can save them to their closet, send them to their handheld device, map a shopping trip by mode of transportation (train, bus, walking directions), contact them directly to hold the item, or make a purchase and have it delivered directly.

And, users can browse and shop the “Style Guide” and “The Blog” by influencer, style, occasion, or season using direct links to that specific content, that includes points of sale. This part of the site is linked through all available social media, as well as retail links found in editorial or email content through visual recognition of posts.

Accordingly, in one aspect of the invention, a method for searching databases related to clothing style and fashion is executed via computer hardware and software. The databases are populated by searchable data related to clothing items, clothing retailers, clothing designers, clothing publications and blogs, clothing style guides. The databases are populated with searchable information and data, including text, photos, editorial content videos and style identification data related to clothing items, clothing retailers, clothing designers, clothing publications and blogs, clothing style guides, by the use of software platforms customized and configured for locating information stored in the databases via SKU based meta-data. These databases are accessible for searching through a clothing style and fashion web based search engine of the invention. The software platforms are supported on or are accessible through a website server of the web based search engine. The method of the invention includes acquiring access to the web based clothing style and fashion search engine through a graphical user interface for receiving, analyzing and responding to queries through one of a plurality of shopping channels including at least an on-line shopping channel, an in-store shopping channel, a mobile shopping channel, a social media shopping channel and an editorial content searching channel; and acquiring access to the web based search engine via a secure sign-up and log-in data entry process thereby viewing on a computer screen a home page of said clothing style and fashion web based search engine. The invention also includes selecting at the home page a high level search option function from among at least clothing items, clothing designers, clothing retailers, geographic location, style guide publications or blog sites, said high level search option function being carried out via software platforms customized and configured for SKU based metadata searching said databases. The results from selecting a high level search option related to specific characteristics of said selected high level options are then received and include secondary web pages illustrating at least clothing item choices, retailer providers, designers and mid-level query options related to said results. Then results from selecting a mid-level query option search on said secondary web page related to specific characteristics of said selected mid-level options are received and include tertiary web pages illustrating at least a specific clothing item choice, and/or a retailer provider, and/or a designer. A next step is then selecting a purchase or save option from the tertiary web pages thereby initiating functions performed via software platforms supported on or accessible through the website server and customized and configured to initiate a purchase and/or save function of said at least clothing item choices, retailer providers and/or designers.

Further, another aspect of the invention is a system for searching databases related to clothing style and fashion, via computer hardware and software, has databases populated with searchable information and data, including text, photos, editorial content videos and style identification data related to clothing items, clothing retailers, clothing designers, clothing publications, blogs, and clothing style guides. A server includes a plurality of software platforms supported by the server or accessible through the server. The software platforms are customized and configured for locating information stored in the databases via SKU based meta-data. The server is connected with and operates a clothing style and fashion web based search engine for searching the databases by said software platforms. A graphical user interface (GUI) is provided for acquiring access to the web based search engine for receiving, analyzing and responding to queries through one of a plurality of shopping channels, including at least an on-line shopping channel, an in-store shopping channel, a mobile shopping channel, a social media shopping channel and an editorial content searching channel. Access to the web based search engine is via a secure sign-up and log-in data entry process to thereby view on a computer screen of a home page of the clothing search engine. A high level search option function available at the home page for selecting from among at least clothing items, clothing designers, clothing retailers, geographic location, style guide publications or blog sites is carried out via software platforms connected with said search engine supported on or through said server and customized and configured for SKU based metadata searching of the databases. Results from selecting a high level search option related to specific characteristic of said selected high level options are receivable at the GUI including secondary web pages illustrating at least clothing item choices, retailer providers, designers and mid-level query options related to said results. Additional software platforms connected with the search engine are customized and configured to build content, including photos, editorial, descriptions, and videos, to populate databases, and to collect data regarding shopping functions by the search engine. Further software platforms are customized and configured to permit scrolling functionality for clothing, brands, retailers, and style content on said search engine. Yet further software platforms are connected with the search engine and are configured to support a back-end SKU based data system. Additional software platforms are configured to facilitate communication between and among the various software platforms for implementing the functionality of the SKU based shopping process; and further software platforms are configured to maintain global retail location data to recognize locations and directions of a given address, for a given retail location.

Another aspect of the invention is a search engine related to a shopping process via computer hardware and software, for searching functions of stored data of clothing style, clothing fashion, clothing retail facilities and their locations, clothing designers, publications and editorial information of clothing style and fashion. The search engine has a website having a graphical user interface (GUI) for receiving queries and other input from a user related to said shopping process and for displaying and viewing of results of said queries and other related information; a server connected with said website; a plurality of software platforms supported on or accessible through said server, said plurality of software platforms being customized and configured to operate said website, and to effect said searching functions; at least one data base connected with said server, said at least one database storing said data of clothing style, clothing fashion, clothing retail facilities and their locations, clothing designers, publications and editorial information of clothing style and fashion, a back-end analytic software platform supported on or accessible through said server, said analytic software platform customized and configured to collect, analyze and aggregate data and other market information generated as a result of said shopping process, and a back-end database connected with said back-end analytic software platform configured to store said data and other market information.

The search engine also has software platforms customized and configured: for SKU based metadata searching of said databases; to permit scrolling functionality for clothing, brands, retailers, and style content on said website; to support back-end SKU based data system; to facilitate communication between and among said various software platforms for implementing the functionality of the SKU based shopping process; and to maintain global retail location data to recognize locations and directions of a given address, for a given retail location.

Yet another aspect of the invention is a method of operating a search engine for a shopping process via computer hardware and software, of searching functions of stored data of clothing style, clothing fashion, clothing retail facilities and their locations, clothing designers, publications and editorial information of clothing style and fashion, comprising: providing a website having a graphical user interface (GUI) for receiving queries and other input from a user related to said shopping process and for displaying and viewing of results of said queries and other related information. The method provides a server connected with said website; using a plurality of software platforms supported on or accessible through said server for effecting said searching functions, said plurality of software platforms being customized and configured to operate said website, and to effect said searching functions; at least one data base connected with said server, said at least one database storing said data of clothing style, clothing fashion, clothing retail facilities and their locations, clothing designers, publications and editorial information of clothing style and fashion, a back-end analytic software platform supported on or accessible through said server, said analytic software platform customized and configured to collect, analyze and aggregate data and other market information generated as a result of said shopping process, and a back-end database connected with said back-end analytic software platform configured to store said data and other market information.

Other features, advantages and embodiments will become apparent from the following detailed description, in connection with the accompanying drawings, and from the appended claims.

### BRIEF DESCRIPTION OF THE DRAWINGS

Embodiments of the invention will be described herein below to provide a full understanding of the invention by reference to the accompanying drawings, in which:

FIG. 1 is a block diagram illustrating various possible channels of shopping for clothing style and fashion;

FIG. 2 is a schematic illustration depicting a user accessing the on-line channel;

FIG. 3 is a screen shot of a home page of the website “Your Style Unzipped”;

FIG. 4(a) is a screen shot of a web page result when choosing a clothing search option from the search bar;

FIG. 4(b) is a screen shot of a web page illustrating a drop down menu when selecting a clothing category search option;

FIG. 4(c) is a screen shot illustrating a web page result after selecting the ‘shoe’ option in the drop down menu of FIG. 4(b);

FIGS. 4(d) and 4(e) are a screen shots illustrating a web page result after selecting the “designer” search option from the search bar;

FIG. 4(f) is a screen shot illustrating a web page result after selecting the “retailer” search option from the search bar;

FIG. 4(g) is a screen shot illustrating a web page result after selecting a particular retailer;

FIG. 5 is a chart illustrating the various search options for the different options on the home page search bar;

FIG. 6(a) is a flow chart illustrating various search steps for each of the shopping channels on-line, in-store, digital, and mobile as illustrated in FIG. 1;

FIG. 6(b) is a flow chart illustrating the various search steps for each of the shopping channels social channel, visual channel and editorial channel, as illustrated in FIG. 1;

FIG. 7(a) is a screen shot illustrating a web page result after selecting the “location” search option from the search bar;

FIG. 7(b) is a screen shot illustrating a web page result after selecting a State and City search option from the web page of FIG. 7(a);

FIG. 7(c) is a screen shot illustrating what GPS location features a user sees when a retailer is chosen from a shopping destination;

FIG. 8 is a screen shot illustrating an Instagram web page result after selecting the “social” search option from the search bar;

FIG. 9 is a screen shot illustrating a Facebook web page result after selecting the “social” search option from the search bar;

FIG. 10 is a screen shot illustrating a web page result after selecting an illustration option from the Instagram page of FIG. 8;

FIG. 11 is an illustration of a saved body scan overlaid on an image of a user;

FIG. 12(a) is an illustration of scanning a barcode;

FIG. 12(b) is a screen shot of an item of clothing which has been identified by scanning its barcode;

FIG. 12(c) is a screen shot of a typical retailer web site;

FIG. 13 is a screen shot illustrating a web page result after selecting a garment via a barcode scan overlaid onto a user body scan as illustrated in FIG. 11;

FIG. 14 is a schematic representation of the various software platforms used to effect the searching functions of the present invention; and

FIG. 15 is a chart illustrating the back-end of analytic and data related functions available to stakeholders.

### DESCRIPTION OF THE INVENTION

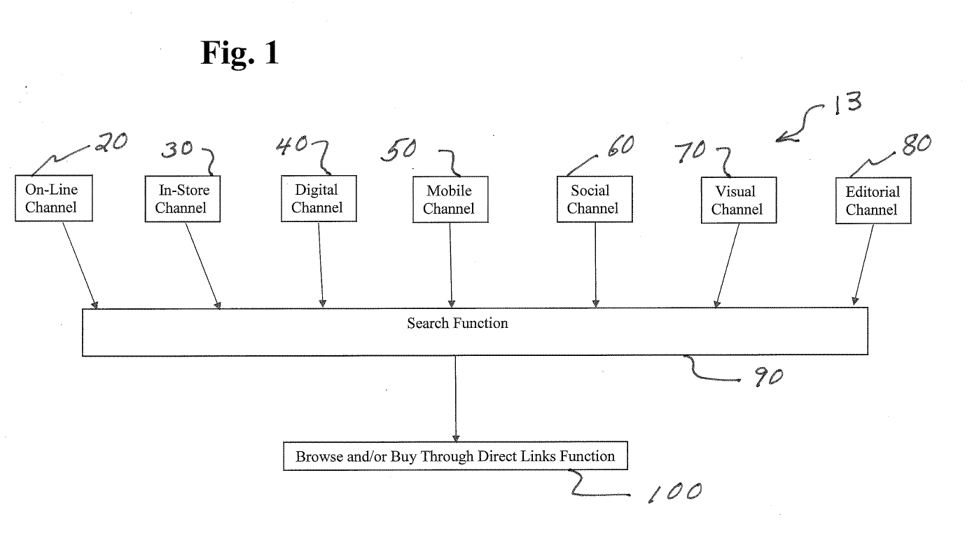

Referring now in more detail to the annexed drawings, FIG. 1 illustrates various possible channels 13 of shopping for clothing style and fashion items. These include an on-line channel 20, an in-store channel 30, a digital channel 40, a mobile channel 50, a social channel 60, a visual channel 70, and an editorial channel 80. A consumer (user) may use any of the enumerated channels for the function of shopping for styles and fashion. Ultimately, each channel will connect a user with a searching function 90 and finally to a function 100 that will allow browsing and/or the purchase of a selected item through a direct link to a site or location that is capable of fulfillment of the order.

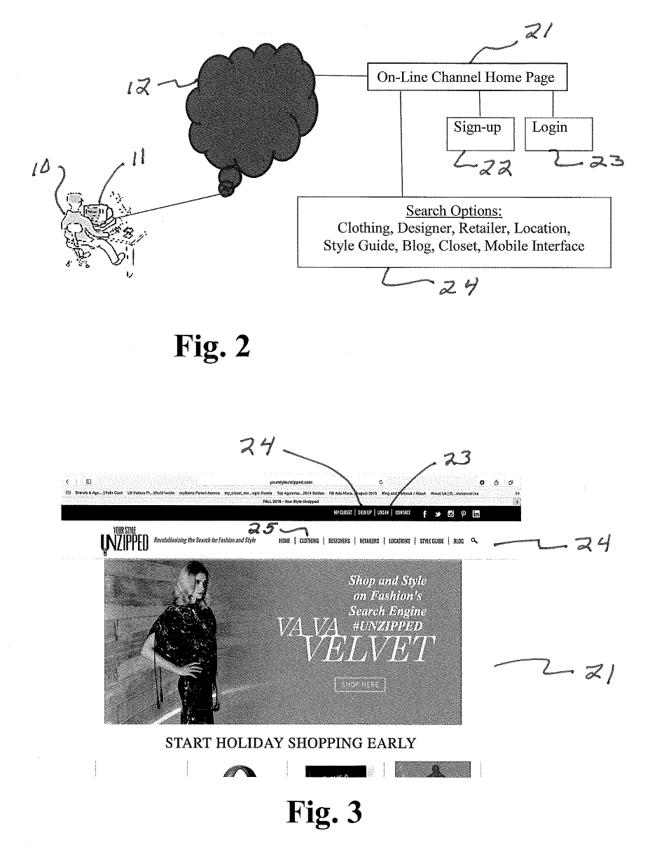

Turning first to the on-line channel 20, as illustrated in FIG. 2, a user 10 may access the system and processes of the invention hosted by the website “Your Style Unzipped”, for example, using a desktop computer 11, through the internet 12. At the home page, through a graphical user interface (“GUI”), the user will be able to view options for signing on to the services of the hosting website at 22 or if already signed up, then logging onto the website, using traditional methods, at 23. Various search options, such as by clothing items, designer, particular retailer or location, by style guide, blogger, closet styles or by mobile interface will be available at a directional board or search bar 24. FIG. 3 is a screen shot of such a home page. The home page is editorial based featuring style, retailers, designers and city locations content.

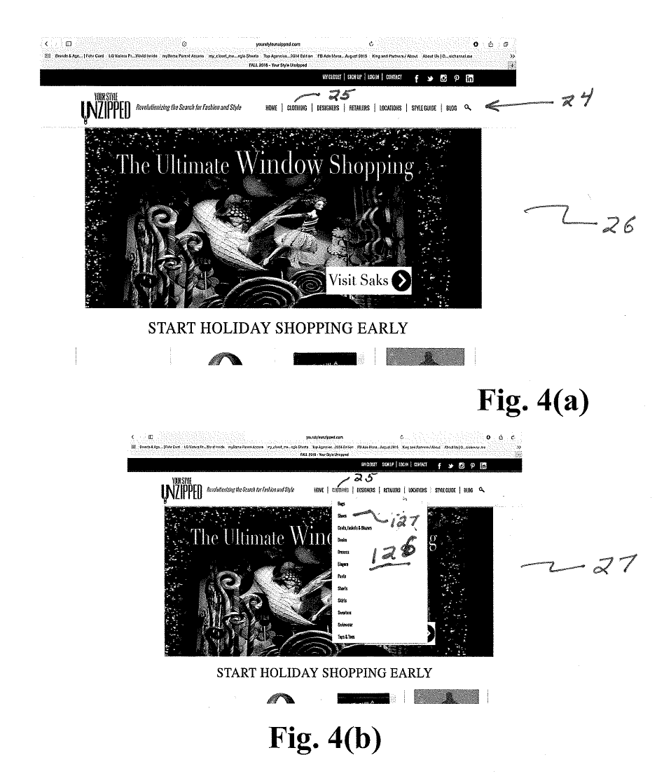

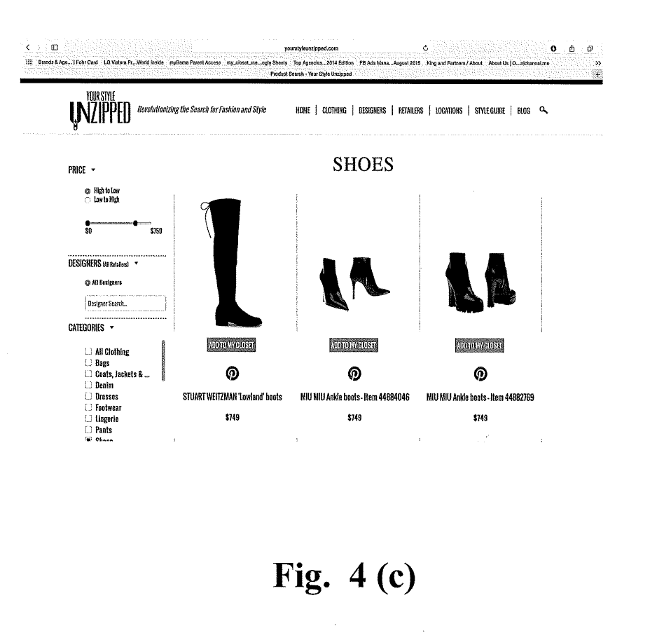

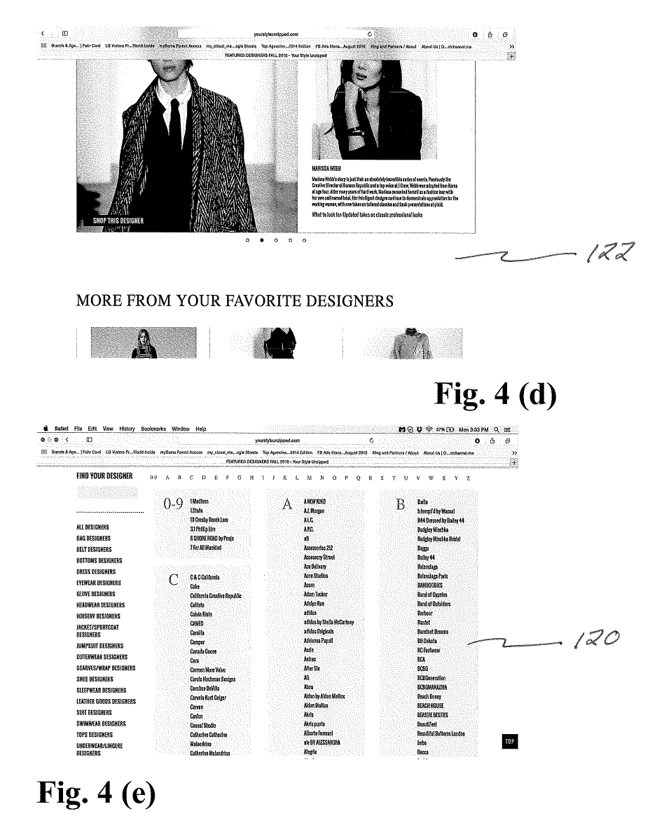

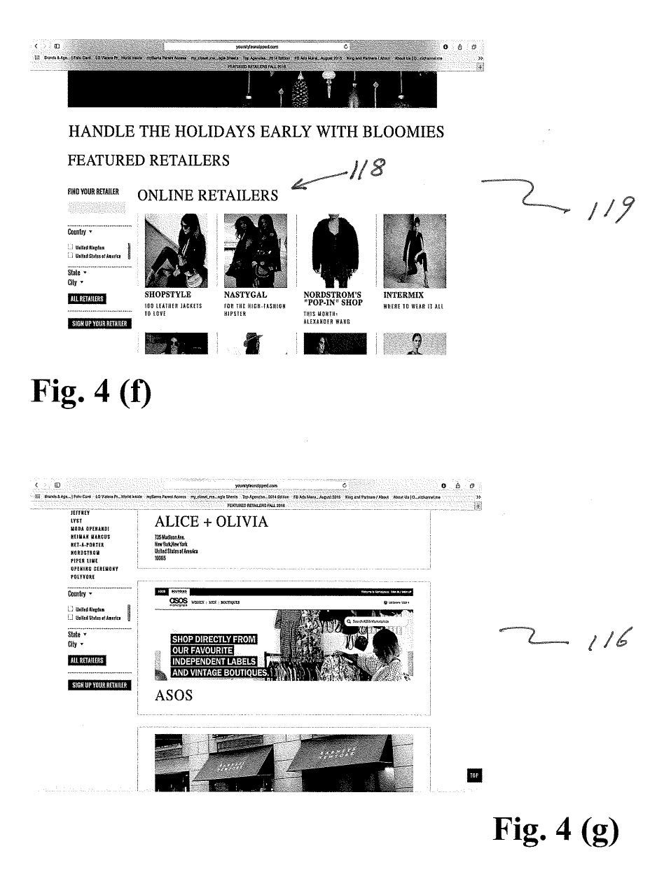

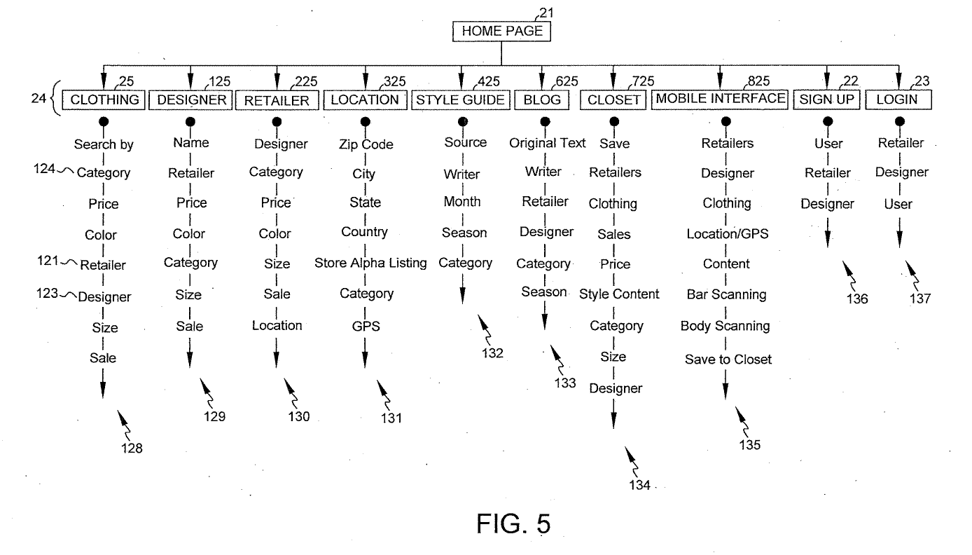

Without logging in a user may still browse the styles and tips which may be exhibited on the home page, and then click onto the content they wish to view more carefully. So, for example if the user wishes to browse the clothing search function, clicking on the clothing choice 25 of the search bar 24 on home page 21 would take that user to pages such as on a screen 26, as illustrated in FIG. 4(a). Hovering over the clothing choice 25 exhibits a window 128 (see FIG. 5) which will display a number of options including category, price, color, retailer, designer, size and sale. By choosing, for example the category choice 124 and clicking on it, a drop down window 126 will appear, as illustrated at the screen 27 displaying further search options. These search options include such areas as bags, shoes, coats and jackets, denim, etc. Clicking on one of the choices on the drop down screen 126, such as for example the choice “shoes” 127, will result in display of a screen shot, such as illustrated in FIG. 4(c). The user can then view the shoes displayed.

The other options on the search bar include designer 125; retailer 225; location 325; style guide 425; blog 625; closet 725; and mobile interface 825.

The array of drop down choices for the options on the search bar 24 is illustrated in FIG. 5. The search areas found in the drop down “clothing” search option 25 are listed at 128, as indicated above. The drop down choices for the “designer” option 125 are listed at 129. The drop down choices for the option of the area retailer option 225 are listed at 130. The drop down choices for the location option 325 are listed at 131. The drop down choices for the style guide option 425 are listed at 132. The drop down choices for the blog option are listed at 133. The drop down choices for the closet option 725 are listed at 134. And the drop down choices for the mobile interface option 825 are listed at 135.

Ultimately, a user may choose to purchase an item found as a result of this searching activity. The user will then follow the appropriate prompts to bring her to the buy function 100 for executing the purchase.

Instead of the user clicking the “category” option 124 of the window 128 (which brings up for view the drop down menu 126) a user may decide to search through the “designer” option 123 of the window 128. This will bring up for view by the user a web page shown at screen shot 122 (see FIG. 4(d)) illustrating a designer page with its features. When the user scrolls down this page, she will find a directory listing 120 of designers, as illustrated on FIG. 4(e). The user would then identify and choose a particular designer for further options.

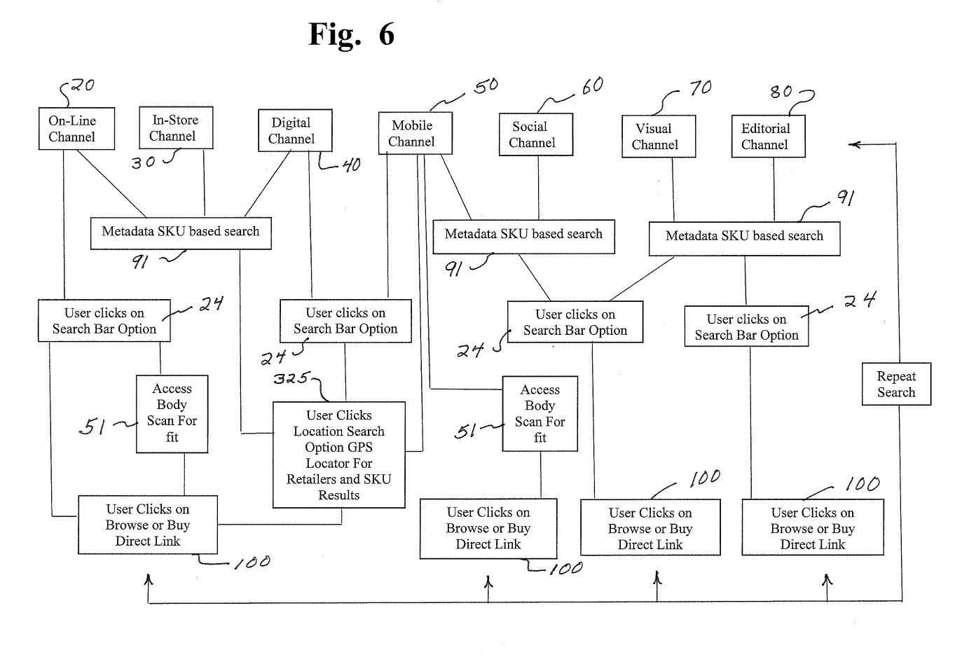

The foregoing description of the on-line channel of search/shopping is exemplary of the searching functions available for the other channels as well. FIGS. 6(a) and 6(b) illustrate broadly the flow of searching for each of the various channels. Similar type screen shots will become viewable when a user elects different options from the first window. For example, screen shot 119 (FIG. 4(f)) will be viewed when a “retailer” option 121 is selected, illustrating featured retailers 118. Scrolling down the page, the user will then find a display of a directory of retailers. Clicking on one such retailer will bring up a page such as illustrated at the screen shot 116 in FIG. 4(g).

Returning to the on-line channel 20, FIG. 6(a) illustrates that a user can execute basic and advanced searches at the SKU based search meta-data function 91 to search for specific items. Once found, the user can also then click on the location search function 325 on the search bar 24. Such execution will trigger the search using GPS based software configured or reconfigured to locate a physical location. Alternatively, the user may go directly to the search bar 24 on the home page 21 to initiate a search for the various functions on the search bar 24, such as location, clothing, brand style, etc.

So, for example, a user may click on the “clothing” option 25 to search for such items as “skinny jeans.” Alternatively, the user my choose the retailer option 225 and seek a specific retailer, such as Nordstrom; or click on the designer option 125 to find a particular designer or designer/brand, such as Michael Kors. Another choice would be to select the style guide option 425 to find a style content (Harpersbazaar.com). A location option 325 can also be selected from the search bar 24. This option is executed using GPS.

Once having obtained the results of the selected search option, the user can, at the Browse and/or Buy Function 100, browse and or buy at the site through a direct purchase hyperlink.

If a user is currently in a retail store and wants to search for an item, the user must be logged into the mobile application. Once there, she has choices.

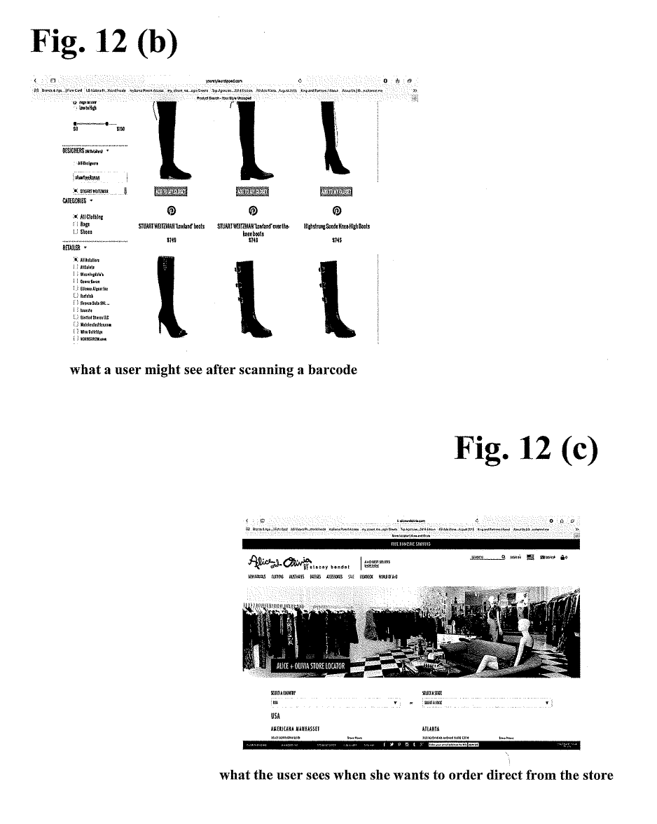

She can scan a barcode of an item in the store using her phone or mobile device (through Apple or integrated partnership software configured to search databases using barcode data) and search for that item using the SKUIQ platform. Scanning a barcode within a store is illustrated in. FIG. 12(a). Once that SKU has been brought up for visualization (see for example FIG. 12(b)), all available colors, sizes, availability and pricing will come up as well. Users can check “availability” for that item with other retailers either online, or by zip code, with the aid of GPS based software, nearest to their current position. They can make a purchase, “hold” an item, or other options available through the retailer. Effecting a purchase may be executed when a user is viewing a store site, such as is illustrated in FIG. 12(c).

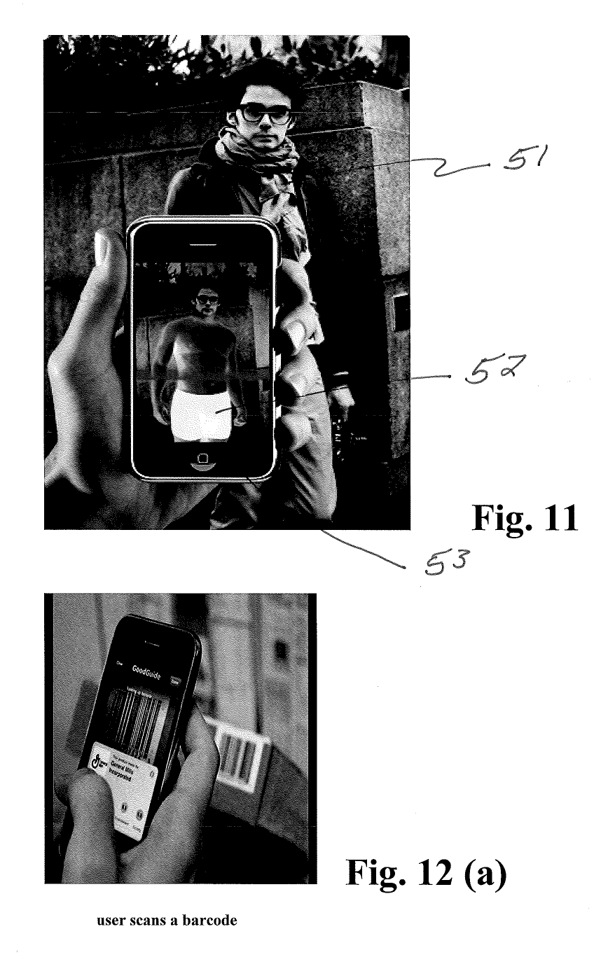

She can also use the “virtual fitting room” 51 capability of her Mobile App. This allows users to pre-scan their body image (using Hot scanning, 3D or other technologies, along with Apple or other integrated software platforms) and save the image to her phone for use when shopping. This is illustrated at FIG. 11. A previously saved body image 52 of a user 51 can be viewed on a mobile device 53. The body image technology had been previously created using known body scanning and imaging technology (such as the above mentioned Hot scanning, 3D technology) and has been stored on the user's mobile device for future use. The technology allows the body scan to be used as an overlay onto an image from a barcode scanned by the user with the mobile device while in a retail facility.

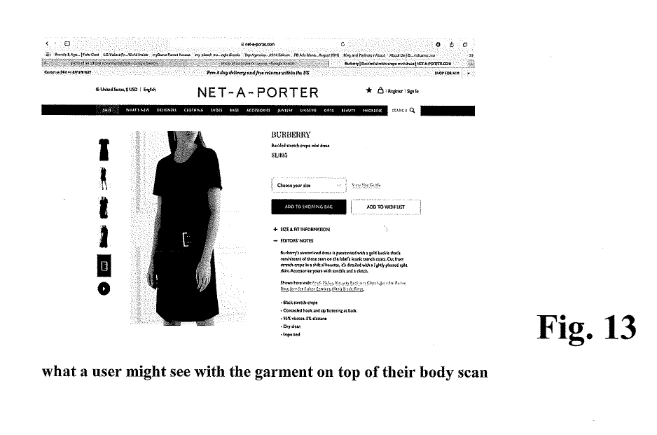

Once the body image is pulled up, users can scan a barcode of an item found in the store or in a search (using the barcoding technology), as is illustrated in FIG. 12(a). The image of that garment will be displayed on the body scan photo, such as is demonstrated in FIG. 13, which illustrates what a user might see with the garment on top of their body scan.

Users can then delete that image, save the image, or scan additional SKU's.

If the user wants to search where to purchase a specific item, he can pull the alphabetical listing by country, state, city, zip code as specified earlier. By linking directly to the Locations search feature which is connected with GPS based Location and Mapping Technology, users can search an item by keyword, numeric, text or visual value.

Once the options in that zip code come up, users can click directly to that retailer's web site, make arrangements to hold the item to buy in-store using communication technology with the store, or purchase for direct delivery through various known delivery services, such as Localz. Users will follow the retailer's specific guidelines and services available through that particular retailer. Once having obtained the results of the selected search option, the user can, at the Browse and/or Buy Function 100, browse and or buy at the site through a direct purchase hyperlink

Users can save any items to their universal “Closet” for future purchase, style assistance, on-sale, in-stock.

Through the digital channel 40, a user may, as with the on-line or in-store channels 20, 30, respectively, execute basic and advanced searches at the SKU based search meta-data function 91 to search for specific items in the same manner as described above. Once found, the user can also then click on the location search function 325 on the search bar 24. Such execution will trigger the search using GPS based software configured or reconfigured to locate a physical location where the item found in the search may be obtained by direct in-store purchase or by executing a purchase link. Alternatively, the user may go directly to the search bar 24 on the home page 21 to initiate a search for the various functions on the search bar 24, such as location, clothing, brand style, etc.

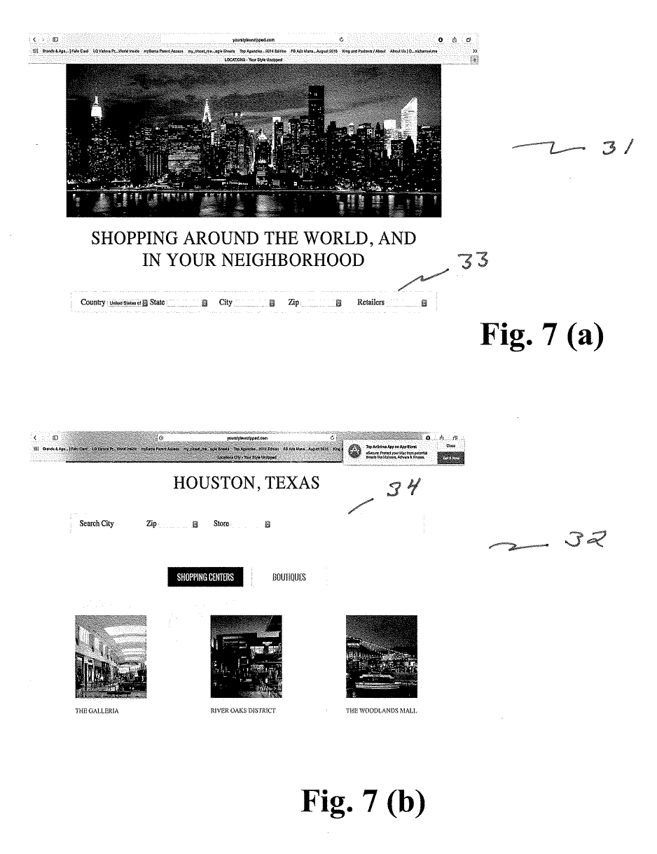

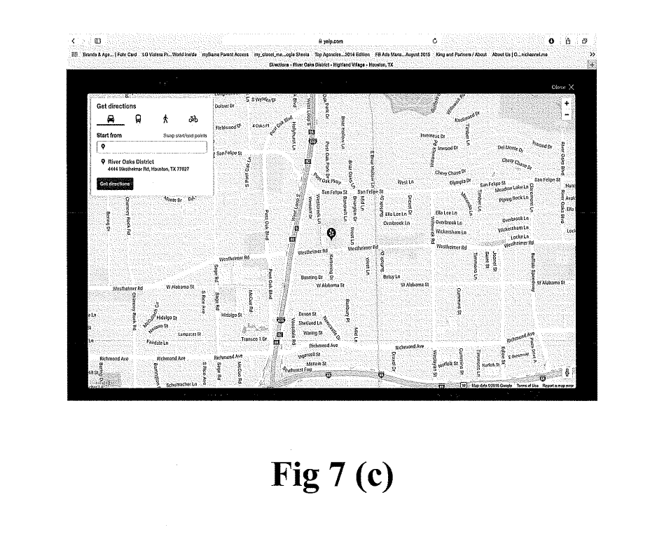

FIGS. 7(a) and 7(b) illustrate web pages on screen shots 31 and 32, respectively, when a user executes a search under “location” 325 of the search bar 24. On web page 31, the user will be able to focus a search to a State, City, Zip code or particular retailer on search bar 33. If, for example, a user enters the name of Houston in the State of Texas into the fields on bar 33, the result would look like the web page 32. Here, the user may further refine the search on bar 34. FIG. 7(c) illustrates what GPS location features the user sees when a retailer is chosen from a shopping destination

Using the mobile channel 50, a user also has the option to initially to execute basic and advanced searches at the SKU based search meta-data function 91 to search for specific items in the same manner as described above. Alternatively, the user may go directly to the search bar 24 on the home page 21 to initiate a search for the various functions on the search bar 24, such as location, clothing, brand style, etc. Once found, the user can also then click on the location search function 325 on the search bar 24. Such execution will trigger the search using GPS based software configured or reconfigured to locate a physical location, as is illustrated in FIGS. 7(a) and 7(b). The found item may then be obtained/purchased by direct in-store purchase or by executing a purchase link.

In addition, via the mobile channel, a user may go directly to the location option on the search bar 24 or may access the “virtual fitting room” 51 capability. This allows users to pre-scan their body image (using configured software known as Hot scanning technology and Apple or other similar available software) and save such scan to her phone for use when shopping. Once the body image is pulled up, users can scan the barcode on an item of clothing or on the tag of an item of clothing (using the barcoding software) and the image of that garment will be displayed on the body scan image. Users can then delete that image, save the image, or scan additional SKU's.

As with the other channels, the user may access the SKU based search meta-data function 91 to conduct searches of publications, barcodes, etc., using filers such as key words, clothing style or item to locate a specific choice.

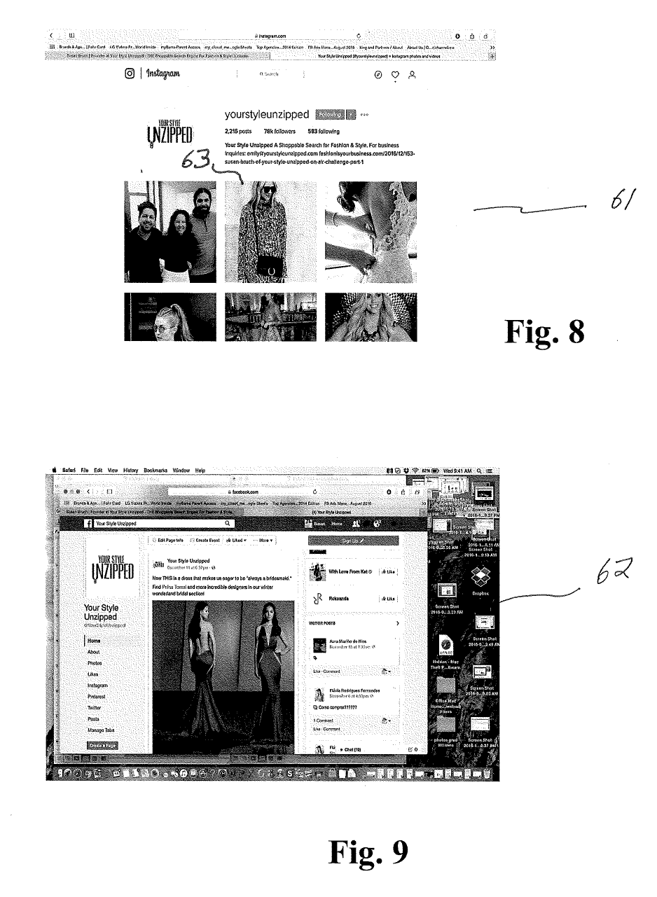

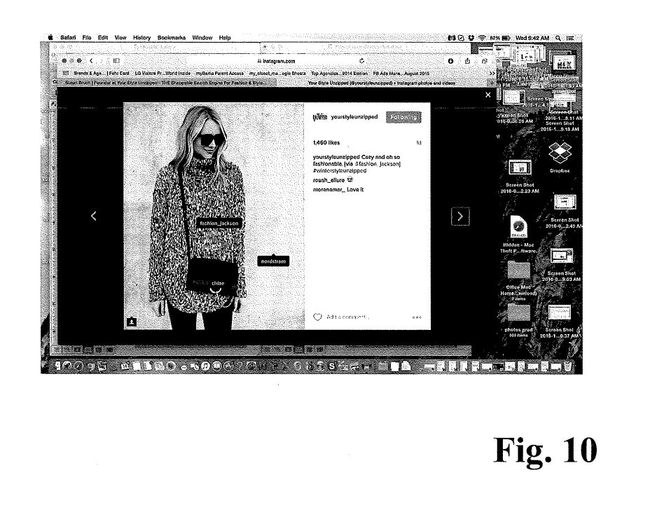

Referring now to FIG. 6(b) users may have access to the systems and methods of the invention through the social channel. When perusing social media sites through the hosting website (“www.yourstyleunzipped.com”), such as Facebook, Instagram, Twitter, Pinterest, etc., a user will have the opportunity to observe ads or links that will allow the searching activity provided by this invention. By clicking on such a link, the user will have all of the availability of the on-line or mobile channels as described above, so that the user may now conduct searches and eventually purchase found items. For example, FIGS. 8 and 9 are screen shots of a pages 61 and 62 respectively from Instagram and Facebook, respectively, both well-known social media sites. From either page a user may initiate searches using the current inventions. For example, a user may click on image 63 in FIG. 8, which will bring up a screen shot of page 64, see FIG. 10. From page 64, the user may then view names and links to brands and/or retailers. The visual and editorial channels will operate in the same or very similar manner.

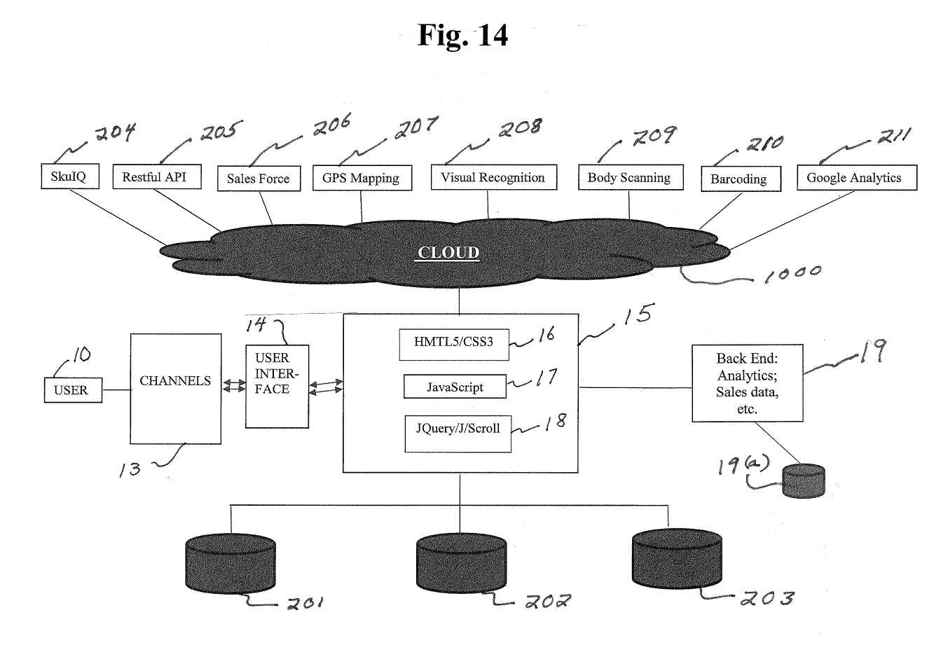

FIG. 14 illustrates, in schematic representation, the various software platforms employed in the present invention. A user 10, through one of the channels 13 discussed above, such as for example the on-line channel 20, is provided access, such as through the user's desk-top computer 11, to a graphical user interface (“GUI”) 14 to the various software platforms employed by the hosting website to effect the searching functions provided by the present invention. Some of the employed platforms are actually housed on a server 15 maintained and operated by the hosting website. These include known, commercially available, software platforms (or customized software platforms) of HTML5/CSS3 16; JavaScript 17 and JQuery/J/Scroll 18.

HTML5/CSS3 16 hosted on server 15 is the primary software platform to build the aggregate content including photos, editorial, descriptions, videos, etc. and to populate for example some of the databases 201, 202 and 203. JavaScript 17 is also hosted on server 15 for constructing most of the shopping process by collecting data for storage in the databases of the system, such as databases 201-203.

JQuery/J/Scroll 18, also hosted on server 15 is a jQuery plug-in that allows users scrolling functionality for clothing, brands, retailers, and style content.

Additional software platforms hosted on servers by others, and available for use by the present system via a link through the cloud 1000 with server 15, include SkuIQ 204, Restful API 205, SalesForce 206, GPS Mapping 207, Visual Recognition 208, Body Scanning 209, Barcoding 210, and Google Analytics 211.

SkuIQ 204 is hosted on a third party's server and customized for use with the present invention to support a back-end sku (product ID) based number system. Restful API 205 is also hosted on a third party's server and customized to facilitate communication between and among the various software platforms for implementing the functionality of the SKU based shopping process. SalesForce 206 is also hosted on a third party's server and customized to accumulate a variety of sales and CRM data analytics through a variety of software platforms sometime referred to as artificial intelligence, and provide mobility all through the system. It will be used for collection of metadata from retailers, brands, data feeds, and vertical digital channels. GPS Mapping software 207, also hosted on a third party server and has been customized to work with the data in one of the databases 201, 202, or 203 which maintains global retail location data to recognize locations and directions of a given address, for a given retail location.

Visual Recognition software 208 is the software platform, hosted by a third party and linked to server 15, customized to work with social media, digital, in-store and mobile applications, in tandem with SkuIQ 204 in order to implement the “see it—buy it” point of sale directly from a photo, video, text, or barcode description or value, as discussed above. Visuals (photos, videos, moving images) can be searched based upon the visual properties it holds (on all digital, mobile and social channels) and guided back through a searchable SKU based (numeric) value system. This enables users to see, search and buy a “black blazer” directly from social media sites, such as Instagram by clicking the image and being directed to a “Browse Now or Buy Now” option process. The Browse Now option will allow search comparisons based upon like Product ID's.

Body Scanning 209 is a software platform hosted on a third party server but customized on a mobile application to fit our platform that works in tandem with barcoding. Barcoding 210 is a software platform also hosted on a third party server and customized on a mobile application to fit with the system of this invention so that it works in tandem with body scanning, as described above.

Google Analytics 211 is a known software platform, also hosted on a third party server, and customized to collect and analyze a variety of data from front end sources to back end.

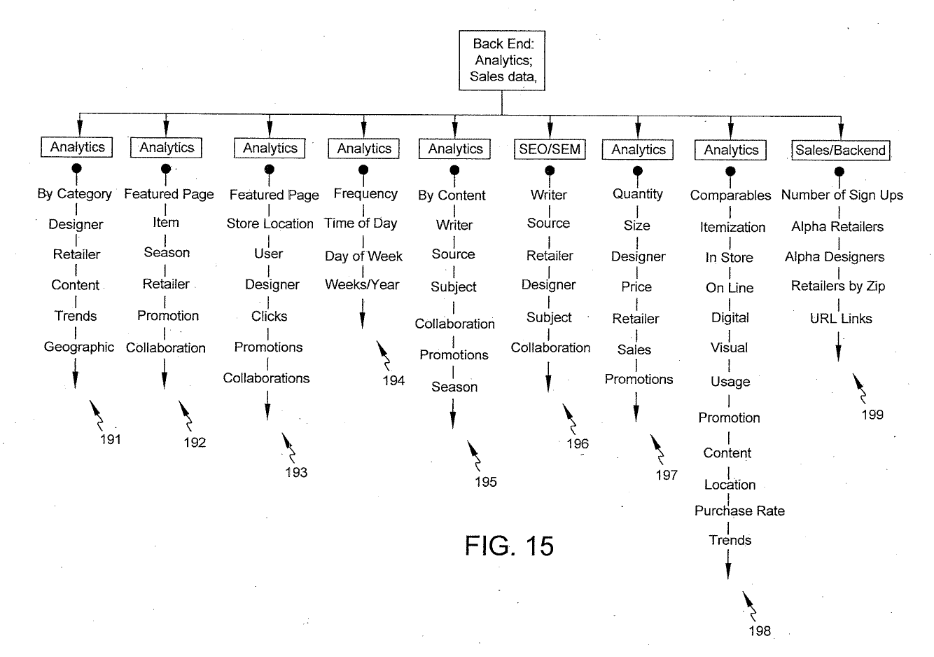

The so-called “back-end” or that part of the system and processes of the invention which collects, analyzes and aggregates data and other market information, is illustrated in FIG. 15, which is a chart illustrating the analytic and data related functions available to stakeholders. The back end 19 is managed and controlled by the various software platforms hosted on server 15 and/or software platforms in contact with server 15 but hosted on third-part servers, through the cloud 1000, as described above. These software platforms are configured to accumulate, generate, aggregate, analyze and store, in a back-end database 19(a), data and information generated as a result of the shopping processes of the front end. As illustrated, the back-end 19 performs analytic functions 191 by consumer shopping trends, category, designer, retailer, content, trends, and geography 191, analytic functions 192 by featured pages, item, season, retailer, promotion, collaboration, analytic functions 193 by featured page, store location, user, designer, clicks, promotions, collaborations; analytic functions 194 by temporal measures of frequency, time of day, day of week, weeks/year; and analytic functions 195 by content, writer, source, subject, collaboration, promotions, and season.

The “back-end” functions also include: SEO/SEM data 196 by writer, source, retailer, designer, subject, collaboration; analytics 197 by quantity, size, designer, price, retailer, sales, promotions; and analytics 198 by Comparables: itemization, in store, on line, digital, visual, usage, promotion, content, location, purchase rate, trends.

The back-end also generates and stores sales data 199 by number of sign ups, user preferences, alpha retailers, alpha designers, retailers by zip code, and URL links.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A method executed via computer hardware and software for searching databases related to clothing style and fashion, said databases being populated by searchable data related to clothing items, clothing retailers, clothing designers, clothing publications, blogs and clothing style guides;
said databases having been populated with searchable information and data, including text, photos, editorial content videos and style identification data related to clothing items, clothing retailers, clothing designers, clothing publications and blogs, clothing style guides, by the use of software platforms customized and configured for locating information stored in said databases via SKU based meta-data; said databases being accessible for searching through a clothing style and fashion web based search engine, said software platforms being supported on or accessible through a website server of said web based search engine;
said method comprising:
acquiring access to said web based clothing style and fashion search engine through a graphical user interface for receiving, analyzing and responding to queries through one of a plurality of shopping channels including at least an on-line shopping channel, an in-store shopping channel, a mobile shopping channel, a social media shopping channel and an editorial content searching channel;
acquiring access to said web based search engine via a secure sign-up and log-in data entry process thereby viewing on a computer screen a home page of said clothing style and fashion web based search engine;
selecting at said home page a high level search option function from among at least clothing items, clothing designers, clothing retailers, geographic location, style guide publications or blog sites, said high level search option function being carried out via software platforms customized and configured for SKU based metadata searching said databases;
receiving results from said selecting a high level search option related to specific characteristics of said selected high level options including secondary web pages illustrating at least clothing item choices, retailer providers, designers and mid-level query options related to said results;
receiving results from selecting a mid-level query option search on said secondary web page related to specific characteristics of said selected mid-level options including tertiary web pages illustrating at least specific clothing item choices, retailer providers, designers; and
selecting a purchase or save option from said tertiary web pages thereby initiating functions performed via software platforms supported on or accessible through said website server and customized and configured to initiate a purchase and/or save function of said at least clothing item choices, retailer providers and/or designers.

2. The method according to claim 1 wherein selecting at said home page said high level search option function of clothing items initiates search functions via said software platforms supported on or accessible through said website server and customized and configured for SKU based metadata searching of said databases thereby resulting in mid-level query options related to said clothing item function, including at least category, price, color, retailer, designer, size and sale.

3. The method according to claim 1 wherein selecting at said home page said high level search option function of designer initiates search functions via said software platforms supported on or accessible through said website server and customized and configured for SKU based metadata searching of said databases thereby resulting in mid-level query options related to said retailer item function, including at designer, category, price, color, size, sale, and location.

4. The method according to claim 1 wherein selecting at said home page said high level search option function of designer initiates search functions via said software platforms supported on or accessible through said website server and customized and configured for SKU based metadata searching of said databases thereby resulting in mid-level query options related to said designer function, including at least name, retailer, price, color, category, size and sale.

5. The method according to claim 1 wherein selecting at said home page said high level search option function of geographic location initiates search functions via a GPS software platform supported on or accessible through said website server and customized and configured for SKU based metadata searching of said databases thereby resulting in mid-level query options related to said geographic location function, including at zip code, city, state, country, store alpha listing, category and GPS location indicia.

6. The method according to claim 1 wherein selecting at said home page said high level search option function of style guide publications initiates search functions via said software platforms supported on or accessible through said website server and customized and configured for SKU based metadata searching of said databases thereby resulting in mid-level query options related to said style guide publications, including at least source, writer, month, season, and category.

7. The method according to claim 1 wherein selecting at said home page said high level search option function of blog sites initiates search functions via said software platforms supported on or accessible through said website server and customized and configured for SKU based metadata searching of said databases thereby resulting in mid-level query options related to said blog sites function, including at least original text, writer, retailer, designer, category and season.

8. The method according to claim 1 further comprising acquiring social media web sites through said web based clothing style and fashion search engine, electing to click on a hyperlink viewable on said social media websites thereby initiating functioning of software platforms supported on or accessible through said website server providing the functionality of said search engine.

9. The method according to claim 8, wherein said hyperlink is a visual image of a clothing item, designer name or retailer name.

10. The method according to claim 1 further comprising acquiring access to said web based clothing style and fashion search engine through a mobile shopping channel for access to said graphical user interface for receiving, analyzing and responding to queries, and using a pre-scanned image of said user on said user's mobile device, said user acquiring an image of said user's body scan having a clothing item overlaid thereon by scanning a barcode of said item via barcoding software platforms supported on or accessible through said website server and customized and configured for said functioning to scan a bar code and overlay an image of said scanned item of clothing on top of said scanned body image.

11. A system for searching databases related to a shopping process of clothing style and fashion, via computer hardware and software, comprising:
databases having been populated with searchable information and data, including text, photos, editorial content videos and style identification data related to clothing items, clothing retailers, clothing designers, clothing publications, blogs and clothing style guides;
a server including a plurality of software platforms supported by said server or accessible through said server, said software platforms customized and configured for locating information stored in said databases via SKU based meta-data;
said server connected with and operating a clothing style and fashion web based search engine for searching said databases by said software platforms supported on or accessible through said server;
a graphical user interface (GUI) for acquiring access to said web based search engine for receiving, analyzing and responding to queries through one of a plurality of shopping channels including at least an on-line shopping channel, an in-store shopping channel, a mobile shopping channel, a social media shopping channel and an editorial content searching channel; access to said web based search engine being via a secure sign-up and log-in data entry process thereby viewing on a computer screen of a home page of said clothing style and fashion web based search engine;
a high level search option function available at said home page for selecting from among at least clothing items, clothing designers, clothing retailers, geographic location, style guide publications or blog sites, said high level search option function being carried out via software platforms connected with said search engine supported on or through said server and customized and configured for SKU based metadata searching said databases, results from said selecting a high level search option related to specific characteristics of said selected high level options receivable at said GUI including secondary web pages illustrating at least clothing item choices, retailer providers, designers and mid-level query options related to said results;
software platforms connected with said search engine and supported on or accessible through said website server customized and configured to build content, including photos, editorial, descriptions, and videos, to populate databases, and to collect data regarding shopping functions by said search engine;
further software platforms connected with said search engine and supported on or accessible through said server customized and configured to permit scrolling functionality for clothing, brands, retailers, and style content on said search engine;
further software platforms connected with said search engine and supported on or accessible through said server customized and configured to support back-end SKU based data system;
further software platforms connected with said search engine and supported on or accessible through said server customized and configured to facilitate communication between and among said various software platforms for implementing the functionality of the SKU based shopping process; and
further software platforms connected with said search engine and supported on or accessible through said server customized and configured to maintain global retail location data to recognize locations and directions of a given address, for a given retail location.

12. The system according to claim 11 further comprising software platforms connected with said search engine and supported on or accessible through said server customized and configured to operate with social media, digital, in-store and mobile applications, in tandem with other software platforms in order to implement a “see it—buy it” point of sale directly from a photo, video, text, or barcode description or value.

13. The system according to claim 12 further comprising software platforms connected with said search engine and supported on or accessible through said server customized and configured to accumulate a variety of sales and CRM data analytics through a variety of other software platforms and provide.

14. The system according to claim 13, wherein said software platforms configured to accumulate a variety of sales and CRM data analytics will be used for collection of metadata from retailers, brands, data feeds, and vertical digital channels.

15. The system according to claim 11, wherein said software platforms configured to maintain global retail location data is GPS Mapping software.

16. The system according to claim 11 further comprising software platforms connected with said search engine and supported on or accessible through said server customized and configured to scan a user body via a mobile device and together with other software facilitates display via said GUI of a clothing item selected by scanning a barcode associated with said clothing item overlaid onto a scan of the user's body.

17. The system according to claim 11 further comprising a software platform connected with said search engine and supported on or accessible through said server customized and configured to collect and analyze a variety of data from front end shopping processes.

18. The system according to claim 17 wherein said software platform configured to collect and analyze a variety of data from front end shopping processes is Google Analytics.

19. The system according to claim 11, further comprising software platforms connected with said search engine and supported on or accessible through said server customized and configured to collect, analyze and aggregate data and other market information generated as a result of said shopping process, and a back-end database connected with said software platforms configured to store said data and other market information.

20. The system according to claim 19, wherein data collected, analyzed, stored and accessible includes such analytics as collected by consumer shopping trends, category, designer, retailer, content, trends, geography, featured pages, clothing item, season, retailer, promotion, collaboration, store location, user, designer, clicks, promotions, temporal measures of frequency, time of day, day of week, weeks/year; and analytic functions by content, writer, source, subject, collaboration, promotions, and season.

21. A search engine related to a shopping process via computer hardware and software, for searching functions of stored data of clothing style, clothing fashion, clothing retail facilities and their locations, clothing designers, publications and editorial information of clothing style and fashion, comprising: a website having a graphical user interface (GUI) for receiving queries and other input from a user related to said shopping process and for displaying and viewing of results of said queries and other related information; a server connected with said website; a plurality of software platforms supported on or accessible through said server, said plurality of software platforms being customized and configured to operate said website, and to effect said searching functions; at least one data base connected with said server, said at least one database storing said data of clothing style, clothing fashion, clothing retail facilities and their locations, clothing designers, publications and editorial information of clothing style and fashion, a back-end analytic software platform supported on or accessible through said server, said analytic software platform customized and configured to collect, analyze and aggregate data and other market information generated as a result of said shopping process, and a back-end database connected with said back-end analytic software platform configured to store said data and other market information.

22. The search engine according to claim 21, wherein said plurality of software platforms include software platforms customized and configured: for SKU based metadata searching of said databases; to permit scrolling functionality for clothing, brands, retailers, and style content on said website; to support back-end SKU based data system; to facilitate communication between and among said various software platforms for implementing the functionality of the SKU based shopping process; and to maintain global retail location data to recognize locations and directions of a given address, for a given retail location.

23. The search engine according to claim 22 further comprising software platforms customized and configured to operate with social media, digital, in-store and mobile applications, in tandem with other software platforms in order to implement a “see it—buy it” point of sale directly from a photo, video, text, or barcode description or value.

24. The search engine according to claim 23 further comprising software platforms customized and configured to build content, including photos, editorial, descriptions, and videos for populating said at least one database.

25. The search engine according to claim 21 further comprising software platforms supported on or accessible through said server customized and configured to accumulate a sales and CRM data analytics generated by said shopping process.

26. The search engine according to claim 25, wherein said software platforms configured to accumulate sales and CRM data analytics will be used for collection of metadata from retailers, brands, data feeds, and vertical digital channels.

27. The search engine according to claim 26, wherein said software platform configured to collect and analyze sales and CRM data analytics is Google Analytics.

28. The search engine according to claim 21, wherein said software platform configured to maintain global retail location data is GPS Mapping software.

29. The search engine according to claim 21, further comprising software platforms connected supported on or accessible through said server customized and configured to scan a user body via a mobile device and together with other software facilitate display via said GUI of a clothing item selected by scanning a barcode associated with said clothing item overlaid onto a scan of the user's body.

30. A method of operating a search engine for a shopping process via computer hardware and software, of searching functions of stored data of clothing style, clothing fashion, clothing retail facilities and their locations, clothing designers, publications and editorial information of clothing style and fashion, comprising: providing a website having a graphical user interface (GUI) for receiving queries and other input from a user related to said shopping process and for displaying and viewing of results of said queries and other related information; providing a server connected with said website; using a plurality of software platforms supported on or accessible through said server for effecting said searching functions, said plurality of software platforms being customized and configured to operate said website, and to effect said searching functions; at least one data base connected with said server, said at least one database storing said data of clothing style, clothing fashion, clothing retail facilities and their locations, clothing designers, publications and editorial information of clothing style and fashion, a back-end analytic software platform supported on or accessible through said server, said analytic software platform customized and configured to collect, analyze and aggregate data and other market information generated as a result of said shopping process, and a back-end database connected with said back-end analytic software platform configured to store said data and other market information.
